(19) United States
(12) Patent Application Publication
(10) Pub. No.: US 2019/0368590 A1
(43) Pub. Date: Dec. 5, 2019

(54) POWERTRAIN COUPLING, CLUTCH, AND TORQUE CONVERTER

(71) Applicant: GM GLOBAL TECHNOLOGY OPERATIONS LLC, Detroit, MI (US)

(72) Inventors: Farzad Samie, Franklin, MI (US); Derek Lahr, Howell, MI (US); Dmitriy Bruder, Auburn Hills, MI (US); Chunhao Lee, Troy, MI (US)

(21) Appl. No.: 16/000,879

(22) Filed: Jun. 5, 2018

(51) Int. Cl. F16H 45/02; F16H 61/14

(52) U.S. Cl. CPC F16H 45/02; F16H 61/14; F16H 2045/005; F16H 2045/0289; F16H 2045/0247

(57) ABSTRACT

A powertrain coupling includes a flexplate configured to be connected to an engine output, a torque converter configured to be connected to a transmission input, and at least one friction clutch disposed between the flexplate and the torque converter and configured for actuation by movement of the torque converter. A powertrain one-way clutch includes engagement elements movably coupled between input and output elements, and at least one friction clutch carried between the input and output elements. A torque converter includes a rear cover, a front cover coupled to the rear cover, and including a frontward facing clutch surface, and a one-way clutch integrated into the front cover and including a one-way clutch plate integrated into the frontward facing clutch surface of the front cover.

### INTRODUCTION

A powertrain clutch is a mechanical device disposed between rotating components to mechanically couple and decouple the rotating components with respect to one another. In an example, a one-way clutch (OWC) couples a drive member to a driven member, transmits torque from the drive member to the driven member, and permits the driven member to overrun the drive member. In general, the one-way clutch includes an input member fixed to the drive member, an output member fixed to the driven member, and one or more engagement members being disposed between the drive and driven members and movable from a clutch engagement position to a clutch disengagement position.

In a more particular example, a selective one-way clutch (SOWC) additionally includes a selector that is actively actuated by some special dedicated means external to the clutch to move the engagement member(s) between the engagement and disengagement positions. In a particular implementation, the SOWC is coupled between a flexplate and a torque converter, and is selectively actuatable to connect the flexplate to the torque converter and to disconnect the torque converter from the flexplate. Some of these SOWC implementations may be commercially satisfactory, but others may be bulky, costly, complex, and/or suffer from undesirable backlash and/or noise.

### SUMMARY OF THE DISCLOSURE

A powertrain coupling according to one aspect of the present disclosure includes a flexplate configured to be connected to an engine output, a torque converter configured to be connected to a transmission input, and at least one friction clutch disposed between the flexplate and the torque converter and configured for actuation by movement of the torque converter.

The powertrain coupling may include additional features or be further defined. For example, the at least one friction clutch may be actuated by at least one of displacement or deflection of the torque converter. Also, a disconnect clutch may be disposed between the flexplate and the torque converter, and may have an input element connected to the flexplate, an output element connected to the torque converter, and one or more movable engagement elements between the input and output elements, and may be locked during engine driving to carry torque from the engine to the transmission but freewheeling when the torque converter rotates faster than the flexplate. Similarly, the torque converter may include a front cover having a portion of the disconnect clutch integrated therein. More specifically, the output element of the disconnect clutch may be fixed to the front cover. Furthermore, the disconnect clutch may include the friction clutch, which may be disposed between the input and output elements of the disconnect clutch. More specifically, the friction clutch may be disposed at a location radially outward of the movable engagement elements of the disconnect clutch. In another embodiment, the friction clutch may be disposed radially inward with respect to the disconnect clutch. Moreover, the friction clutch may be disposed between the flexplate and the front cover. Also, the friction clutch may include a friction material carried by a friction clutch plate that is more resistant to axial deflection than the flexplate. Additionally, the friction clutch plate may be fixed with respect to the flexplate and the friction material may be fixed to the friction clutch plate for engagement with the torque converter. Finally, the friction clutch may include a polycone clutch disposed between the flexplate and the torque converter.

A powertrain one-way clutch according to another aspect of the present disclosure includes an input element, an output element, a plurality of engagement elements movably coupled between the input and output elements, and at least one friction clutch carried between the input and output elements.

The powertrain one-way clutch may include additional features or be further defined. For instance, the at least one friction clutch may be disposed radially outward of the plurality of engagement elements. Also, the input element may be a notch plate, the output element may be a pocket plate, and the plurality of engagement elements may include a plurality of forward struts.

A torque converter according to another aspect of the present disclosure includes a rear cover, a front cover coupled to the rear cover, and including a frontward facing clutch surface, and a one-way clutch integrated into the front cover, and including a one-way clutch plate integrated into the frontward facing clutch surface of the front cover.

The torque converter may include additional features or be further defined. For instance, the one-way clutch plate may be a pocket plate. Also, a friction clutch annulus may be disposed at a location radially outward of the pocket plate. Additionally, a clutch support rim may extend axially away from the frontward facing clutch surface. Finally, a friction clutch annulus may be disposed radially inward of the clutch support rim.

### BRIEF DESCRIPTION OF THE DRAWINGS

FIG. 1 is a schematic view of an embodiment of a powertrain including an engine, and a transmission coupled to the engine by a powertrain coupling, which includes a flexplate, a torque converter, and one or more clutches between the flexplate and the torque converter;

FIG. 2 is a fragmentary, cross-sectional view of an embodiment of a powertrain including a flexplate, a torque converter, and an overrunning clutch between the flexplate and the torque converter with an integrated friction clutch;

FIG. 3 is a fragmentary, cross-sectional view of the powertrain of FIG. 2, additionally including another friction clutch axially between the flexplate and the torque converter and radially inward of the overrunning clutch; and

FIG. 4 is a fragmentary, cross-sectional view of an embodiment of a powertrain including a flexplate, a torque converter, an overrunning clutch between the flexplate and the torque converter, and a polycone clutch between the flexplate and the torque converter.

### DETAILED DESCRIPTION

In general, a powertrain coupling, clutch, and torque converter are disclosed. In a particular implementation, a powertrain includes an engine, and a transmission coupled to the engine by a powertrain coupling. The powertrain coupling includes a flexplate connected to the engine, a hydrodynamic torque converter connected to the transmission, an engine disconnect clutch that is engageable to carry engine driving torque, and a friction clutch that connects the torque converter to the flexplate and that may carry engine braking torque or engine driving torque. The powertrain coupling may improve fuel economy of the powertrain by reducing engine drag via disconnection of the engine from the transmission.

It is known that a torque converter moves somewhat during operation and that such movement should be accommodated in the design of a powertrain, but the presently disclosed powertrain not only accommodates, but affirmatively uses, such movement to actuate one or more clutches external to the torque converter. Accordingly, the powertrain coupling is actuated by displacement and/or deflection of the torque converter. Also, the torque converter may include a portion of the disclosed clutch integrated therewith, to facilitate packaging of the disclosed clutch between the flexplate and the torque converter with no increase in powertrain length.

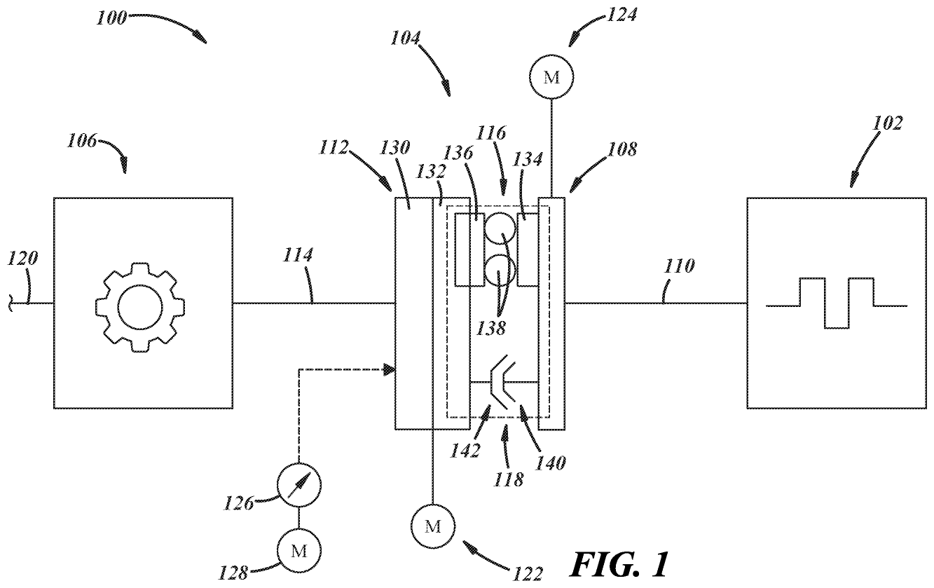

With reference now to the drawing figures, FIG. 1 illustrates embodiments of the disclosed powertrain coupling, clutch, and torque converter. A powertrain 100 includes an engine 102, a powertrain coupling 104, and a transmission 106 coupled to the engine 102 by the powertrain coupling 104. The powertrain coupling 104 includes a flexplate 108 connected to an output 110 of the engine 102, a torque converter 112 connected to an input 114 of the transmission 106, an overrunning clutch 116 between the flexplate 108 and the torque converter 112, and a friction clutch 118 between the flexplate 108 and the torque converter 112. As indicated by a dashed line rectangle, the overrunning clutch 116 may include the friction clutch 118, or the friction clutch 118 may be separate from the overrunning clutch 116.

The engine 102 may be an internal combustion engine that may be powered by combustion of gasoline, diesel, natural gas, or any other suitable fuel, or may be any other engine suitable for use in providing torque to downstream portions of a powertrain and may be powered in any suitable manner. In any case, the engine output 110 may include, for instance, an output shaft, such as a crankshaft, rotor shaft, or any other output suitable for use in providing torque to downstream portions of a powertrain.

The transmission 106 may be a multi-speed transmission, a continuously variable transmission, or any automatic transmission suitable for being coupled to an engine in a powertrain. The transmission 106 may include the input 114, an output 120, and one or more torque multipliers (not shown) therebetween. The input 114 may include a turbine shaft that may be connected to the torque converter 112. The output 120 may be configured for connecting or coupling to downstream equipment, for example, to a drivetrain of a vehicle. The torque multipliers may include gearsets, belts/sheaves, and/or any other torque multipliers suitable to provide rotational mechanical advantage.

The powertrain 100 may be a hybrid-electric powertrain, which may include an electric motor 122 in a P2 hybrid configuration, coupled to the torque converter 112, as illustrated. In other embodiments, the motor 122 may be coupled to the transmission input 114, the transmission output 120, or to any suitable elements of the transmission 106 between the transmission input 114 and output 120. Of course, the motor 122 may be a motor/generator that may produce an output of torque from an input of electricity and that may produce an output of electricity from an input of torque. Additionally, the powertrain 100 may include a starter motor 124 that may be coupled to the flexplate 108 for use in starting of the engine 102. The starter motor 124 may be a 48-volt brushless fast start (BFS) motor. Moreover, the powertrain 100 may include an auxiliary pump 126 that may be used to provide auxiliary hydraulic pressure to the torque converter 112, and an auxiliary motor 128 that may be used to drive the pump 126. In another embodiment, the powertrain 100 may be in the form of a P2.5 hybrid configuration, wherein the motor 122 may be coupled to an intermediate node within the transmission 106, for instance, to one of multiple planetary gearset nodes.

The torque converter 112 may include a rear cover 130, and a front cover 132 coupled to the rear cover 130 by welding, integral forming, fastening, or any other connecting technique suitable for a torque converter. Although not shown, the torque converter 112 may include a driving impeller fixed to an inside of the rear cover, a driven turbine connected to the input 114 of the transmission 106, a stator in fluid communication between the impeller and the turbine to redirect hydraulic fluid back to the impeller, and a lock-up clutch to lock the turbine relative to the impeller. Unlike conventional torque converters, the presently disclosed torque converter front cover 132 may omit conventional threaded studs or bosses that are conventionally used to couple a flexplate to a torque converter.

The overrunning clutch 116 may be a one-way clutch (OWC), which may be integrated into the front cover 132 of the torque converter 112, and may include, for instance, a pawl clutch, a sprag clutch, a roller clutch, or any other suitable one-way clutch. In any case, the overrunning clutch 116 may include an input element 134, an output element 136, and movable engagement elements 138 therebetween. The input element 134 may be fixed to the flexplate 108, for instance, via welds, integral formations, fasteners, or any other suitable mechanical connection. In other embodiments, the input element 134 may be an integral portion of the flexplate 108. The output element 136 may be fixed to the torque converter 112, for instance, via welds, integral formations, fasteners, or any other suitable mechanical connection. In other embodiments, the output element 136 may be an integral portion of the torque converter 112. For instance, the output element 136 may include a one-way clutch plate integrated into a frontward facing clutch surface of the torque converter front cover 132. The movable engagement elements 138 may include forward struts, sprags, rollers, or any other movable elements suitable for use in a one-way clutch, and may be retained by one or both of the input or output elements 134, 136, and/or by one or more other retainers (not shown). Likewise, the overrunning clutch 116 may include any other suitable components, for instance, springs, clips, or the like, depending on the type of clutch used. Also, in a preferred embodiment, the overrunning clutch 116 is not a selective OWC.

The friction clutch 118 may be a disc clutch, cone clutch, or any other clutch suitable for use in carrying torque, for instance, engine braking torque, in a powertrain. The friction clutch 118 may include an upstream or front element 140 connected to the flexplate 108, and a downstream or rear element 142 connected to the torque converter 112. The friction clutch 118 may be a device separate from, but in parallel with, the overrunning clutch 116, or may be integrated with the overrunning clutch 116. When the powertrain 100 is not operating, an axial gap may be present between the elements 140, 142 of the friction clutch 118.

An example scheme for operation of the powertrain 100 is discussed below.

In an engine driving mode, the engine 102 operates such that the engine output 110 rotates the flexplate 108, which rotates the torque converter 112 via locked up engagement of the overrunning clutch 116, wherein the clutch input element 134 drives the clutch engagement elements 138 against the clutch output element 136, such that there is no slip across the friction clutch 118. The friction clutch 118 may, but need not, be engaged in the engine driving mode.

In an engine off mode, wherein a transmission rotational speed exceeds an engine rotational speed, the overrunning clutch 116 is freewheeling and torque converter hydraulic pressure is relatively low such that torque converter 112 does not move enough to engage the friction clutch 118.

In an engine on, engine braking mode, torque converter hydraulic pressure is relatively high such that the torque converter 112 is displaced and/or deflected an amount sufficient to cause engagement of the friction clutch 118. Such engagement of the friction clutch 118 during overrunning may prevent or at least reduce ratcheting of the overrunning clutch 118. The torque converter hydraulic pressure may need to be raised to provide the relatively high amount of pressure sufficient to cause friction clutch engagement. For example, hydraulic pressure supplied to the torque converter may be raised by a hydraulic regulating circuit of the transmission 106.

In an engine autostart mode, the overrunning clutch 116 is engaged or holding, and friction torque prevents the overrunning clutch engagement elements 138 from lifting off, for instance, under conditions involving a torque reversal or moment during which the clutch 116 is transmitting zero torque and the torque converter 112 overruns the engine 102. Likewise, in an engine cranking mode, when the starter motor 124 is used to rotate the flexplate 108, the overrunning clutch 116 is engaged. In a motor/generator start mode, the auxiliary motor 128 may be used to drive the auxiliary pump 126 to hydraulically pressurize the torque converter 112 to an amount sufficient for engagement of the friction clutch 118.

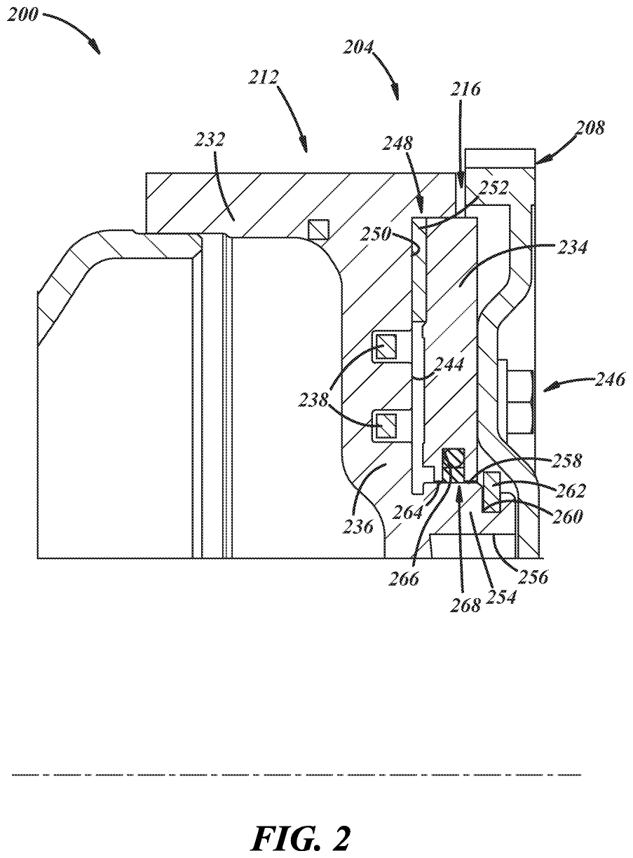

FIGS. 2-4 show other illustrative embodiments of the disclosed powertrain. These embodiments are similar in many respects to the embodiment of FIG. 1 and like numerals between the embodiments generally designate like or corresponding elements throughout the several views of the drawing figures. Accordingly, the descriptions of the embodiments are hereby incorporated into one another, and description of subject matter common to the embodiments may not be repeated.

In a specific implementation of the disclosed powertrain, FIG. 2 illustrates a powertrain coupling 204 of a powertrain 200, including a flexplate 208, a torque converter 212, and an overrunning clutch 216 having an input element 234 connected to the flexplate 208 and an output element 236 integrated into a frontward facing clutch surface 244 of the torque converter 212. The input element 234 may be a notch plate, which may be fixed to the flexplate 208 by a threaded fastener 246, which may pass through a corresponding hole (not shown) in the flexplate 208, and may include a bolt threaded into a front surface of the input element 234, or a threaded stud (not shown) fixed to the input element 234 and threaded to a nut at a front surface of the flexplate 208. The output element 236 may be a pocket plate that may take the form of a pockets machined, stamped, or otherwise produced in a front surface of the torque converter 212. The overrunning clutch 216 also may include movable engagement elements 238, for instance, pawls, carried in the output element 236.

The torque converter 212 also may include a friction clutch annulus 248, which may be disposed at a location radially outward of the integrated output element 236. The friction clutch annulus 248 may include an annular surface 250 machined or otherwise processed to have a surface finish suitable for engagement with a friction element 252, which may include friction material, may be in the form of a plate or disc, or any other suitable geometry, and may be fixed to the overrunning clutch input element 234 by welding, integral forming, fastening, or in any other suitable manner. In another embodiment, the friction clutch annulus 248 may include friction material, which may be fixed to the torque converter 212 by welding, integral forming, fastening, or in any other suitable manner for engagement by a corresponding machined or processed surface of the overrunning clutch input element 234. In any case, the corresponding friction clutch portions of the torque converter 212 and the overrunning clutch input element 234 constitute a friction clutch. The friction clutch provides for engagement of the torque converter 212 with the flexplate 208, such as when the torque converter 212 deflects and/or displaces during operation.

The torque converter 212 includes a front cover 232 that includes a clutch support rim 254 extending axially away from the frontward facing clutch surface 244. The rim 254 may have a radially inner surface 256, and a radially outer surface 258 that may carry an annular groove 260, which may carry a clutch retainer 262 and may have a surface that is machined or otherwise suitably processed to support the overrunning clutch input element 234. For example, the overrunning clutch input element 234 may include a radially inner surface 264 having an annular groove 266 to accommodate one or more bearing elements 268. The bearing elements 268 may include, for instance, rings, bushings, or any other bearing elements suitable to facilitate axial sliding motion between the input element 234 and the clutch support rim 254. In any case, the torque converter 212 may be axially retained to the flexplate 208 between the retainer 262 and the frontward facing clutch surface 244.

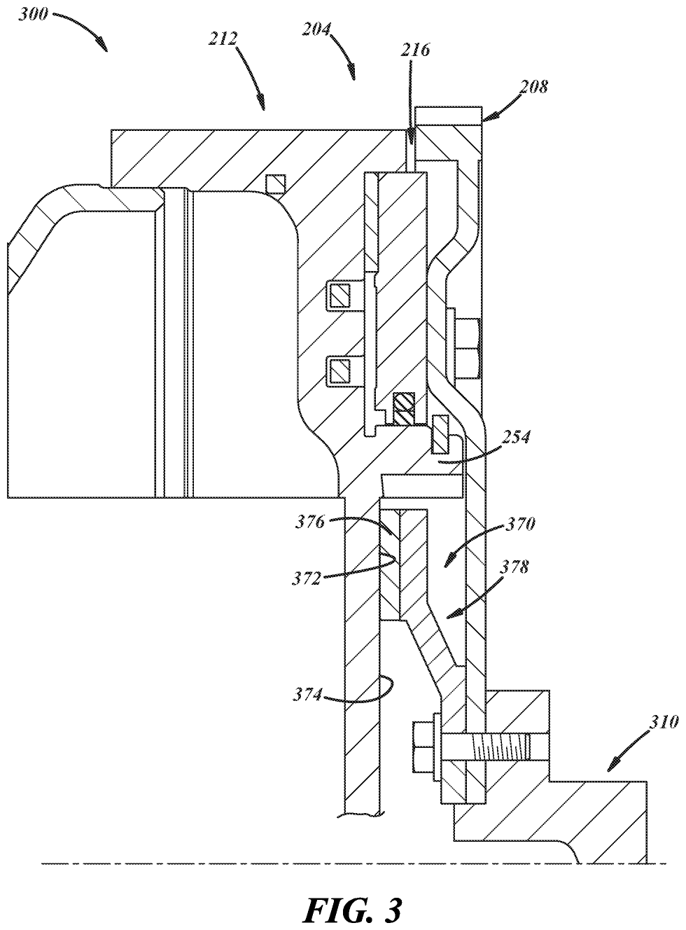

In an alternative implementation of the disclosed powertrain, FIG. 3 illustrates a powertrain 300 including the powertrain coupling 204 of FIG. 2, but additionally including a radially inner friction clutch 370, which may be disposed radially inward of the overrunning clutch 216, and also may be disposed radially inward of the clutch support rim 254. The friction clutch 370 may include a friction clutch annulus 372 on a front facing surface 374 of the torque converter 212 that may be machined or otherwise suitably processed to cooperate with friction material. Additionally, the friction clutch 370 may include a friction material 376 carried by a friction clutch plate 378, which is stiffer or more resistant to axial deflection than the flexplate 4208. The friction clutch plate 378 may be fixed to the flexplate 208 and/or an engine output 310 and the friction material 376 is carried by the friction clutch plate 376 for engagement with the torque converter 212 when the torque converter 212 deflects and/or displaces during operation. It is contemplated that the radially inner friction clutch 370 may either supplement or replace the radially outer friction clutch 216. When the powertrain 300 is not operating, an axial gap may be present between the cooperating elements of the friction clutch 370, more specifically, between the friction material 376 and the friction clutch annulus 372.

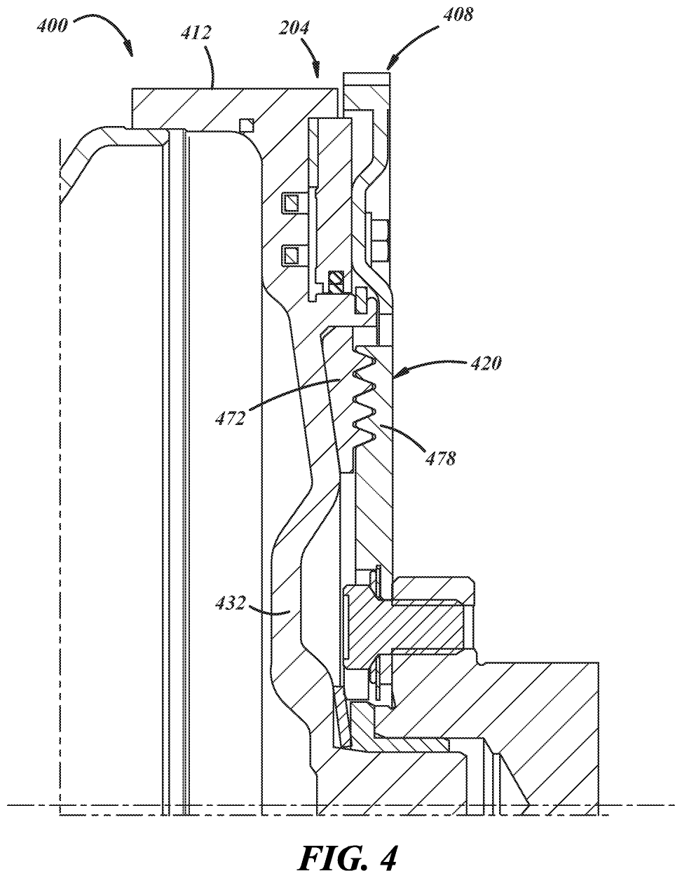

In another alternative implementation of the disclosed powertrain, FIG. 4 illustrates a powertrain 400 including the powertrain coupling 204 of FIG. 2, but additionally including a radially inner polycone friction clutch 470. The polycone friction clutch 470 may include a first portion 472 that may include a component separate from a front cover 432 of a torque converter 412 and welded, integrally formed, fastened, or otherwise attached thereto in any other suitable manner. The clutch 470 also may include a second portion 478 that may be integrated into a rearward facing surface of a flexplate 408. The polycone friction clutch 470 is characterized by annular, radially spaced, interdigitated, cone-shaped elements to provide large surface area contact over a radially compact region.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

What is claimed is:

1. A powertrain coupling, comprising:
a flexplate configured to be connected to an engine output;
a torque converter configured to be connected to a transmission input; and
at least one friction clutch disposed between the flexplate and the torque converter and configured for actuation by movement of the torque converter.

2. The powertrain coupling set forth in claim 1, wherein the at least one friction clutch is actuated by at least one of displacement or deflection of the torque converter.

3. The powertrain coupling set forth in claim 1, further comprising a disconnect clutch being disposed between the flexplate and the torque converter, having an input element connected to the flexplate, an output element connected to the torque converter, and one or more movable engagement elements between the input and output elements, and being locked during engine driving to carry torque from the engine to the transmission but freewheeling when the torque converter rotates faster than the flexplate.

4. The powertrain coupling set forth in claim 3, wherein the torque converter includes a front cover having a portion of the disconnect clutch integrated therein.

5. The powertrain coupling set forth in claim 3, wherein the torque converter includes a front cover, and wherein the output element of the disconnect clutch is fixed to the front cover.

6. The powertrain coupling set forth in claim 3, wherein the disconnect clutch includes the at least one friction clutch, which is disposed between the input and output elements of the disconnect clutch.

7. The powertrain coupling set forth in claim 6, wherein the friction clutch is disposed at a location radially outward of the movable engagement elements of the disconnect clutch.

8. The powertrain coupling set forth in claim 1, wherein the friction clutch is disposed radially inward with respect to the disconnect clutch.

9. The powertrain coupling set forth in claim 1, wherein the torque converter includes a front cover, and wherein the friction clutch is disposed between the flexplate and the front cover.

10. The powertrain coupling set forth in claim 1, wherein the friction clutch includes a friction material carried by a friction clutch plate that is more resistant to axial deflection than the flexplate.

11. The powertrain coupling set forth in claim 10, wherein the friction clutch plate is fixed with respect to the flexplate and the friction material is fixed to the friction clutch plate for engagement with the torque converter.

12. The powertrain coupling set forth in claim 1, wherein the friction clutch includes a polycone clutch disposed between the flexplate and the torque converter.

13. A powertrain one-way clutch, comprising:
an input element;
an output element;
a plurality of engagement elements movably coupled between the input and output elements; and
at least one friction clutch carried between the input and output elements.

14. The powertrain one-way clutch set forth in claim 13, wherein the at least one friction clutch is disposed radially outward of the plurality of engagement elements.

15. The powertrain one-way clutch set forth in claim 13, wherein the input element is a notch plate, the output element is a pocket plate, and the plurality of engagement elements includes a plurality of forward struts.

16. A torque converter, comprising:
a rear cover;
a front cover coupled to the rear cover, and including a frontward facing clutch surface; and
a one-way clutch integrated into the front cover, and including a one-way clutch plate integrated into the frontward facing clutch surface of the front cover.

17. The torque converter set forth in claim 16, wherein the one-way clutch plate is a pocket plate.

18. The torque converter set forth in claim 16, further comprising a friction clutch annulus disposed at a location radially outward of the pocket plate.

19. The torque converter set forth in claim 16, further comprising a clutch support rim extending axially away from the frontward facing clutch surface.

20. The torque converter set forth in claim 16, further comprising a friction clutch annulus disposed radially inward of the clutch support rim.
